(19) United States
(12) Patent Application Publication
(10) Pub. No.: US 2011/0063965 A1
(43) Pub. Date: Mar. 17, 2011

(54) MULTIPLEXED DATA STORAGE METHOD

(76) Inventor: Sandor Lako, Kecskemet (HU)

(21) Appl. No.: 12/310,015

(22) PCT Filed: Dec. 27, 2006
(86) PCT No.: PCT/HU2006/000129

§ 371 Date: Jul. 20, 2010

(30) Foreign Application Priority Data
Aug. 8, 2006 (HU) PCT000064

(51) Int. Cl. G11B 7/00

(52) U.S. Cl. 369/100; G9B/7

(57) ABSTRACT

The core of the present invention is a method and an apparatus for transformation of matter parameters through optical way. In course of said method, a multilateral pattern inside a sample matter is created by means of a specific imaging beam emitted by a light emitting device. The most significant application of the suggested method is for writing on optic data storage media. Further application concerns the analysis of the above-mentioned optical parameters, i.e. reading data from the storage media.

The core of the invention is a method and apparatus for transformation of matter parameters through optical way. In course of this method we create a multilateral pattern inside sample matter through specific imaging beam issued by a light emitting device. The most significant application of the suggested method is for writing on optic data storage media. Further application concerns the analysis of the above-mentioned optical parameters, i.e. reading data from the storage media. The invention can provide an extensive increase in storage capacity and data processing rate while ensuring compatibility with existing and forthcoming DVD technologies and fulfilling the requirements of industrial-scale reproduction.

Because of space limitations, detailed description of data storage technology cannot be provided here even for replaceable storage media. To narrow the circle, we can safely state that neither silicon nor magnetic based storage devices can compete with the DVD because of their respective cost efficiency. In the following sections, the most important technologies using optics as the key area will be discussed from the viewpoint of our invention.

It seems practical to differentiate between surface and volumetric technologies. Surface technologies that is coding on one or maximum on a few surfaces, mostly similar to current technologies, generally try to minimize the information coding surface element. The linear dimension of the surface element, however, is a parameter difficult to change, and the limit of data reading and mainly writing is in reverse ratio to this size, which gives little hope to significantly increase data speed. The reduction of the surface element can be achieved optically through reducing and/or increasing the numeric aperture.

The wavelength of solid-state light sources is extremely difficult to reduce below the 405 nm value currently used in the Bluray technology. Apart from the traditional tools of increasing the numeric aperture, the technologies moving to the direction of increasing numeric aperture also have to use the effect of evanescent space so that we can achieve NA values higher than the unit. Due to the integration of the evanescent space into the data carrier, which requires extreme preciseness and the elimination of all mechanical interfering effect, this research tendency is highly risky because it jeopardizes the changeability of optical data medium, which is their unique benefit compared to other technologies.

The magneto-optical solutions allow resolution below diffraction limit through the phase switching of the Curie-point which has better localizability than that of the electromagnetic field. The phase switching with controllable size runs on a few percent of the diffraction limited focal point as a result of which storage capacity significantly increases but this technology has much less yield in the field of data speed. On the one hand, the rate of the linear size reduction is lower than that of the surface element. Besides, the key problem of these procedures is the poor signal-to-noise ratio, the improvement of which can be achieved by the utilization done during the reading of the above threshold effect (Magnetic-Super-Resolution, MSR). As in the case of achieving good signal-to-noise ratio, reading also depends on the threshold effect, apart from the size of the coding surface element, its duration also limits the reading speed.

Apart from the reduction of the addressed surface element, using some kind of grey scale is also an opportunity to increase the information content of the surface element. Its gain, however, is limited because secure detection is uncertain even with a few bits, and the related literature allows us to conclude that it results in an especially slow writing speed.

Apart from such significant benefits as high data speed and data density, we can state in general about volumetric technologies that their mechanical/optical complication, special data medium move their application costs to an order of magnitude different from the surface technologies. These systems are usually also burdened with compatibility problems, and apart from fast and suitable diffraction efficiency of holographic data recording, they require performance higher by an order of magnitude than required by diode lasers used in the current optical technologies.

There are of course exceptions almost to all above statements but there is no technology that can offer a solution to the described problems while keeping the mentioned benefits.

One of the promising technologies named C3D is a solution using fluorescent detection. It basically is a system of discs placed on each other where the use of fluorescence is to reduce the noise level of detection to the desired level. Data speed basically equals to the speed of a single-layer disc but the capacity can significantly be increased. Apart from this drawback, this quasi-volume (based on multi-layer structure) data recording technology has the benefit of easily developable compatibility.

With the combination of two-photon fluorescence and confocal detection, data storage volume can be significantly reduced by the sensitivity of the system makes the application of the rotating data medium unlikely. And its price, due to the ultra-short pulse laser systems, excludes an everyday application.

The holographic methods of really volumetric data storage, in comparison to present day regular optical drivers are systems involving a much higher order of complexity. The volume multiplexed system and its cost-efficient and robust production have been unresolved up to now, although the idea came up 30 years ago. The holographic technology has an interesting domestic relation, too. The current and former researchers of BME (Budapest University of Technology and Economics) have successfully been working in the field of holographic data recording. The main drawback of the proposed solutions—besides complexity—the potential rewriting becomes generally possible only after the complete deletion of the stored data. Two tentative solutions to this problem are worth mentioning. G. Szarvas et al., “Multilayer Thin-film Holographic Storage”, Technical Digest of ISOM/ODS 2002, Joint International Symposium on Optical Memory and Optical Data Storage 2002, 7-11 Jul. 2002, Hawaii, pp. 240-242, IEEE Catalog No. 02EX552, 2002, and the patent description US 2003156309, “Confocal holographic optical storage with non overlapping records”. The latter, although it resolves the problem of rewriting, requires a powerful laser to produce a high quality beam and thus cannot be industrially replicated.

The first development—a device using polarization holograms fixed in multi-layer structure—aims at a wider application. Of the currently researched holographic technologies, this latter device shows the most promising features from industrial viewpoint. The system is much simpler and has higher tolerance limits than other holographic technologies and does not contain any moving parts apart from the spinning of the data recording disc and the addressing solution of the data carrier layers. But compared to current systems, it still has complicated optical system. Furthermore it is relatively costly to manufacture the carrier of one to two hundred layers, and addressing the data carrier layers is complicated while the increase of its data speed due to multiplexing is limited. All this motivates further developments in the field of holographic recording.

As far as volumetric data recording systems are concerned, it needs be emphasised that they impose very high requirements of the light sources, which makes the applied lasers costly, while systems applying cheap laser diodes are in reality only quasi-volumetric methods that read/write only a single layer at a time. Thus, cost efficient volumetric data storage points towards the necessity of further research in the direction of the light sources. The main purpose of the invention is to create a high speed/high capacity data storage system, which would preclude the technical difficulties encountered in the earlier research.

I have recognised that multiplexed optical data storage does not necessarily require the application of a holographic recording method, because superimposed layers of the multi-layer storage medium can be written and read simultaneously with the application of a suitable light source and imaging optical setup. In most general terms, the method outlined in the introductory paragraphs can be realized by imaging of any binary sequence into the sample: for the each element of the sequence the imaging setup will simultaneously create focus-volumes in different positions of the media, while the interrelated positions of these volumes will be fixed.

The preferred implementation of our invention applies laser beams with non-conventional topology. Based on relevant literary sources, in this section we give an overview of methods for producing Bessel beams. Bessel-Gauss beams [F. Gori, G. Guttari, C. Padovani, “Bessel-Gauss beams”, Opt. Comm. 64 (6), 491-495 (1987)], or other truncated Bessel beams [L. Vicari, “Truncation of non-diffracting beams” Opt. Comm. 70, 263-266 (1989)] as quasi non-diffracting beams came to the focus of scientific study at the end of the 1980's, mainly because of the especially high focal depth of focusing achievable with such beams. In experimental setups they were first produced by truncating a relatively easily producible laser beam utilizing an annular aperture and focusing the resulting beam (Durnin method). Subsequently, proposals for producing the beams in a laser resonator have also been published. However, a laser resonator generating a beam with Bessel-like topology has not yet been created. The fundamental reason behind the failure to provide such a resonator is that published proposals apply such special optical elements [A. A. Tovar, “Production and propagation of cylindrically polarized Laguerre-Gaussian laser beams”, JOSA A 15, 10 2705-2711 (1998)] that cannot be produced in a quality necessary for laser operation.

So far, the application of Bessel-type beams has been oriented towards exploiting their peculiar focusing characteristics. The main appeal of this beam type was originally its extremely high focal depth, but that has been lately complemented by the great variety of realizable polarization states. The topology which is characteristic for Bessel-type beams permits a polarization state which can render focusing sharper than ever [R. Dorn, S. Quabis, G. Leuchs, “Sharper focus for radially polarized light beam”, PRL 91, 23 233901 (2003)].

On the above grounds, it would be evident to call for the application of this beam type in the field of micromachining, especially for technologies utilizing non-linear or threshold effects, or in certain subfields of multiphoton fluorescence microscopy. However, these applications are seriously hindered by the fact that—at least in case the aim is to reap the advantages of high focal depth—they require significantly higher pulse energies and/or peak power (higher even by orders of magnitude) than setups applying conventional beams with much shorter beam neck focused to a spot of similar half value width. Because these Bessel-type beams can only be derived from conventional beams at the cost of significant energy losses, the development of Bessel-Gauss lasers should be a preferred research direction from the aspect of data recording but also that of micromachining and microscopy. A substantial advance has been made in the field of special intensity-distribution laser beams with the introduction of surface-emitting fibre lasers [Ofer Saphira et al., “Surface emitting fiber-laser” Opt Express 14 3929-3935 (2006)]. However, these lasers are not mode-locked, and polarization properties of the output are not optimal.

From the aspect of the inventive recognition special emphasis should be laid on the work done in the field of superluminal propagation by Zsolt Bor and his colleagues [Z. Horvàth et al., “Acceleration of femtosecond light pulses to superluminal velocities by Gouy phase shift” Appl. Phys. B 63 481-484 (1996)], especially their calculations motivating me to examine Gouy phase anomaly. For the deeper understanding of the phenomenon I found it especially fruitful to decompose the angular spectrum of the Gauss beam into Bessel beams. In the case of pulses propagating as Bessel components, a pulse propagating in the direction of the optical axis with superluminal group velocity appeared in case of each component. This has lead me to the recognition that for Bessel beams individual spatial portions of the optical axis having an extension commensurable with the half value width of the focus, and more generally, similar spatial portions of an axis pointing into a direction significantly different from directions within the angular spectrum are not in action connection even in the case when a relatively small separation distance, dependent on their normal-to-axis extension and the angular deviation of the latter axis, is introduced between them. This means, on the one hand, that the positions of constituents of a pattern similar to the above mentioned one, consisting of uniform shapes and being disposed on the optical axis, can be definitely recovered from the diffracted beam, for instance with the application of a relatively simple arrangement described below, in the section dealing with the disclosure of the invention. On the other hand, by reversing this operation it is in principle possible to modulate individual spatial portions of the optical axis separately from one another. Laser beams with conventional topology do not have this property, which, although does not exclude their application for multiplexing, but still affects the stability of the system negatively.

The elaboration on, and the recognition of the technological applicability of another idea, namely that obstructing the central maximum of Bessel beams causes the maximum to reappear in the course of the propagation of the beam [Belyi et al., “Properties of parametric frequency conversion with Bessel light beam” Opt. Comm. 162 169-176 (1999)], also plays a central role in the invention. According to my calculations complete regeneration occurs at the above mentioned “separation distance” from the location of obstruction.

It is worth stressing the importance of the DVD type technology where one bit is coded on one unit of the media space (any given point of media can be definitively correlated with one bit). It can be interpreted in a seas that data writing is a kind of reworking of the media, i.e. creation of a structure of some kind within the media substance. The process of reading data in case of these technologies becomes a sort of microscopic examination of the substance of the media. This approach forestalls the possible micromachining and microscopical applications of the data storage technology disclosed below. The well-known use of two-photon photopolymerisation for the production of micro-structures, which enables a fairly precise operating through infra-red laser pulses, is a further support to the legitimacy of our approach.

### DISCLOSURE OF THE INVENTION

The invention will be presented with reference to the following drawings:

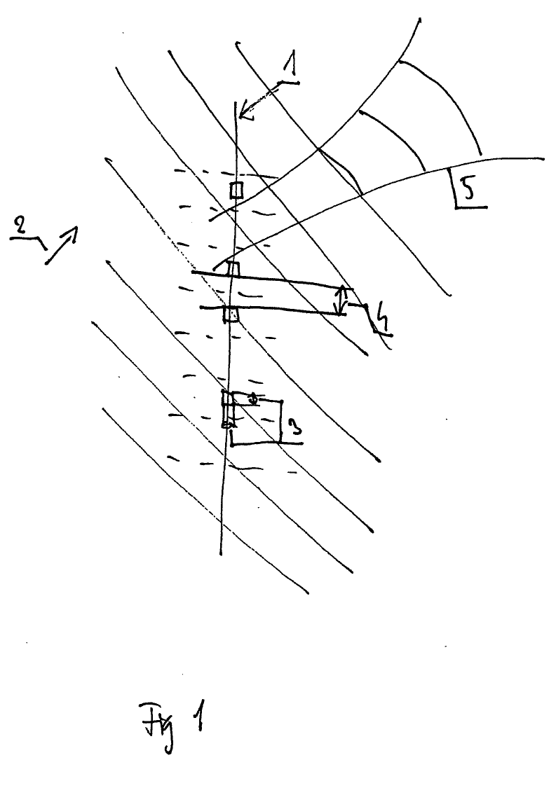

FIG. 1 illustrates the action connections of volume portions applied for coding individual bits,

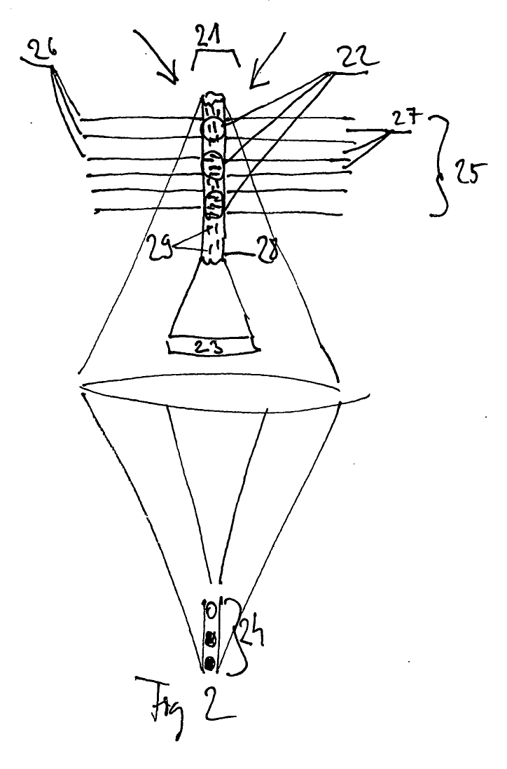

FIG. 2 shows the schematic view of an optical setup applicable for multiplexed data recording utilizing a conventional optical setup,

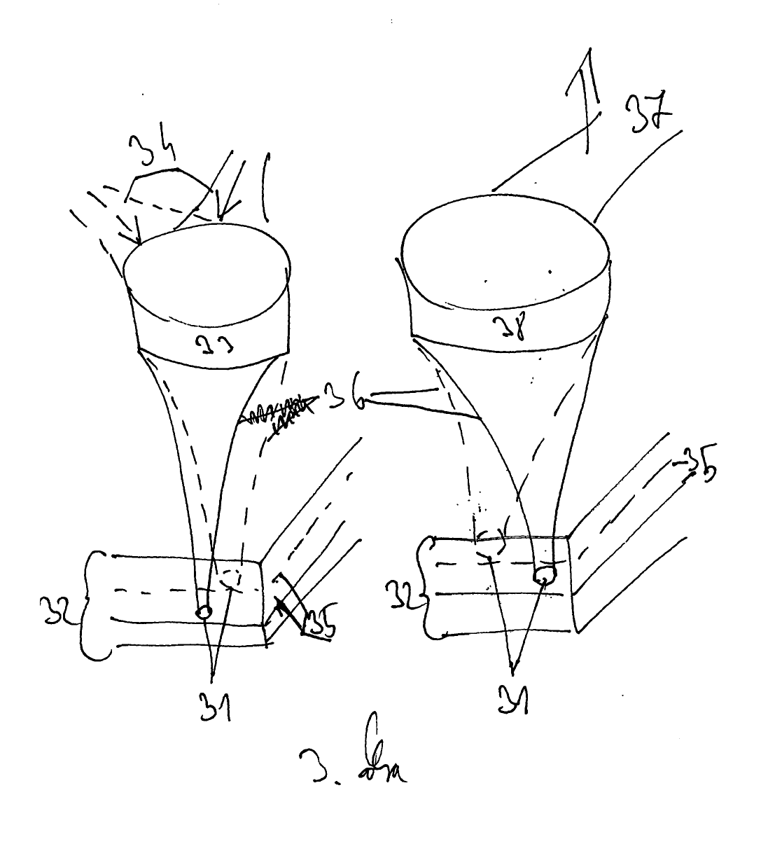

FIG. 3 shows an arrangement comprising a holographic imaging element, applicable for multiplexed data recording and retrieval,

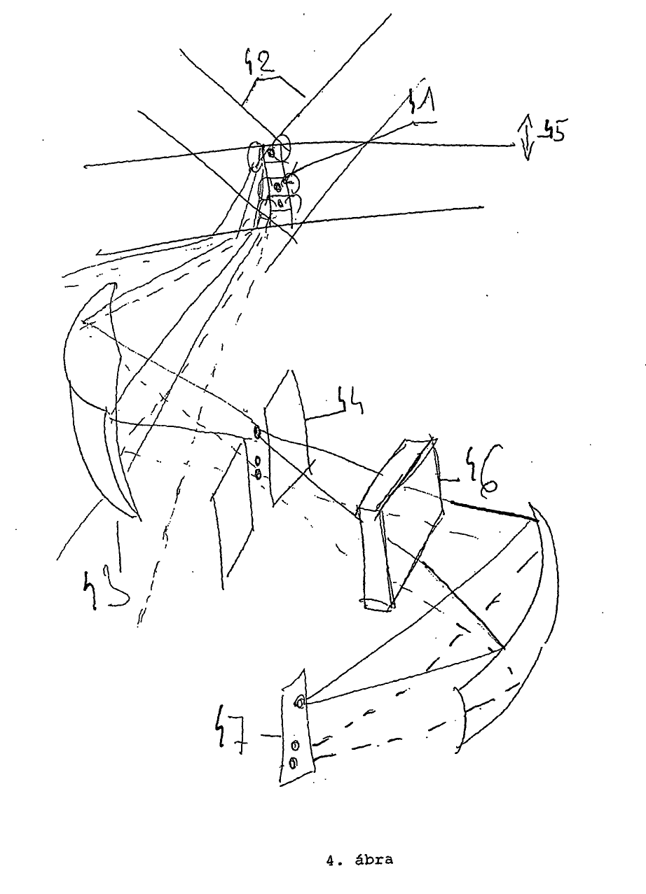

FIG. 4 shows an implementation of a confocal detector setup applied for the multiplexed retrieval of an aligned bit pattern.

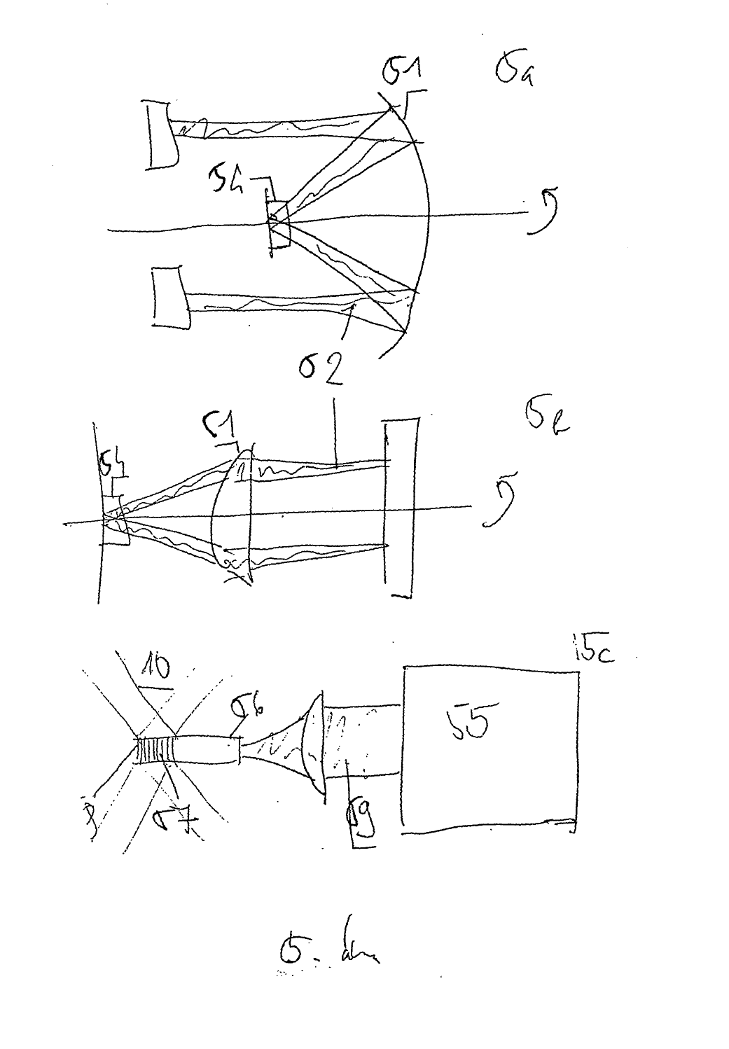

FIG. 5 shows the simplest possible arrangements for a light source emitting a Bessel-Gauss beam, with FIG. 5a showing an arrangement utilizing a high-aperture mirror, FIG. 5b showing an arrangement utilizing a high-aperture lens, and FIG. 5c showing a laser setup utilizing the cylindrical surface of an optical fibre as a coupling-out element

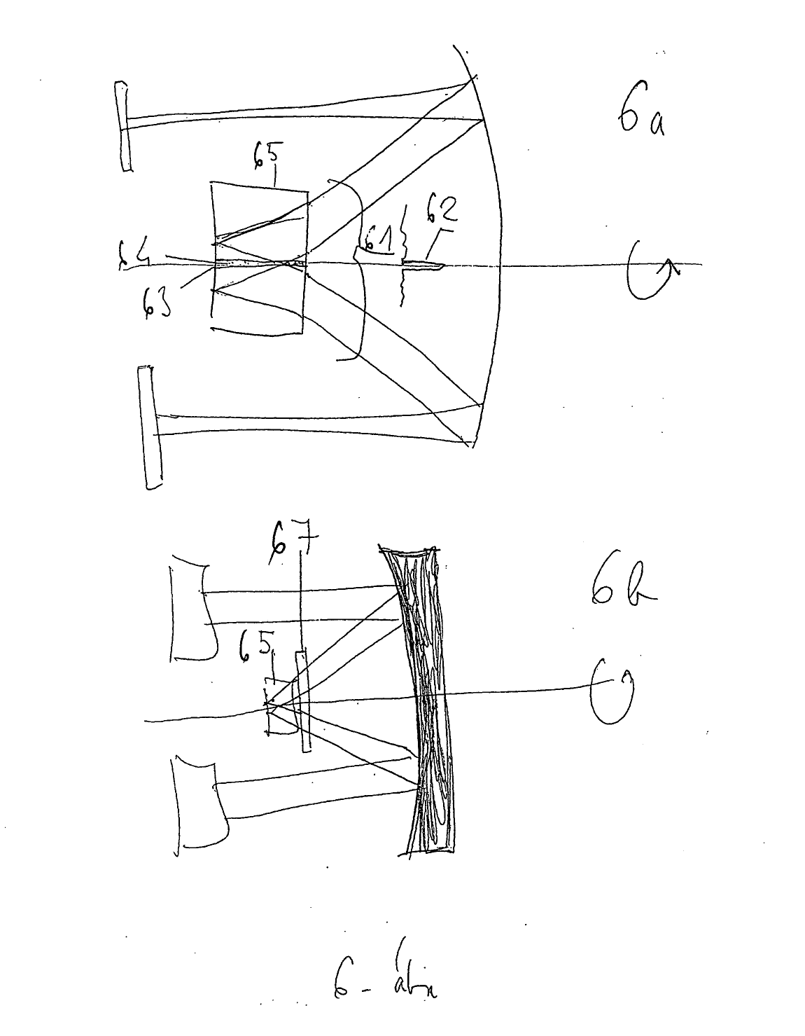

FIG. 6 illustrates a pulse-regime Bessel-Gauss laser resonator, with FIG. 6a showing an implementation of a Bessel-Gauss laser resonator with mode-synchronized output where the mode synchronizing element is disposed inside the laser-active material, and FIG. 6b showing an implementation of a Bessel-Gauss laser resonator comprising Q-switched output

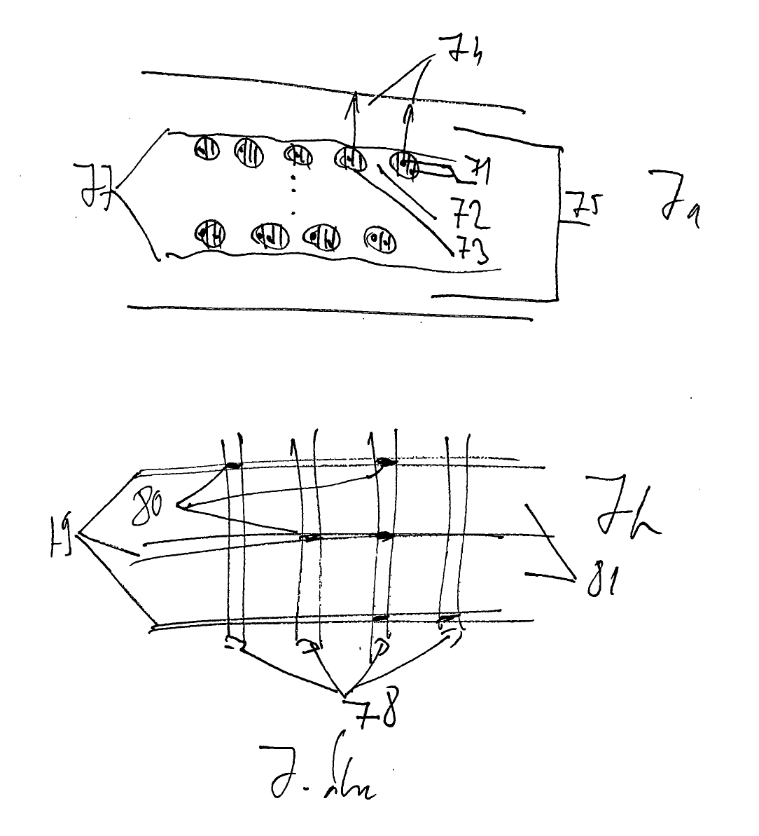

FIG. 7 shows implementations of the data storage medium, FIG. 7a showing a PDLC storage medium, and FIG. 7b illustrating a multilayer medium.

### DETAILED DESCRIPTION OF THE INVENTION WITH REFERENCE TO THE ACCOMPANYING DRAWINGS

I have recognised that multiplexed optical data storage does not necessarily require the application of a holographic recording method, because superimposed layers of the multi-layer storage medium can be written and read simultaneously with the application of a suitable light source and imaging optical setup. Conditions for a possible simultaneous writing/reading arrangement are illustrated in FIG. 1., where a plain wave diffracted by a bit array. Simultaneous writing and reading can be achieved by means of an optical setup where there is significant angular separation (significant meaning at least 5°) between the axis 1 of the inscribed bit pattern and the propagation direction 2 of the Fourier-components of the light beam both during writing and reading. This requirement provides that the bits to be recorded do not interact with one another in case small-size volume elements 3 and a large enough separation distance 4 are applied. The separation distance 4 can be taken to be proportional to the normal-to-axis extension of the volume elements applied for data storage and to the cosine of the smallest angle between the Fourier-components of the beam and the axis of the bit pattern, by way of analogy with diffraction of a plain wave on an oblique slit 5 and in accordance with the principle of superposition (the zeal beam is created by the superposition of the plain wave components).

A special case of reading/writing of the bits is when the optic axis of the reading/writing beam is perpendicular to the linear bit pattern. The direction of bits to be written in the medium can fortuitous and generally the invention deals with any bit sequences. The only restriction as to their geometric position is that the relative position of all bit coding volumes must remain unchanged.

On the other hand, I have recognised that it is possible to simultaneously write to and read from spatial portions located at different distances from the surface of the storage medium—eventually from positions on slightly different projected to the discsurface and from several lateral positions at the same depth—by means of a holographic imaging element that is capable of simultaneously focusing beams from multiple light sources with high numerical aperture (or, alternatively, beams generated by splitting the beam of a single light source).

The light-source needed for the readout is by nature capable of the same imaging. However it can be even more easily achieved with the help of one undivided-beam laser and a holographic optical element. This latter setup is shown in FIG. 3. The data multiplexing comes about through simultaneous reading and writing of a bit pattern. The medium would then contain the multitude of the fixed position bit patterns arranged purposefully in rows or tracks written spirally on a disk.

FIG. 2 shows an optical setup adapted for imaging a bit pattern. The figure shows the axis cut of the setup, which has rotational symmetry to the optic axis. In my recognition, any off-axis imaging transformation limited only to the extent that it should provide a small enough image of the bit pattern to be recorded (with the pattern playing the role of the object of the imaging), for instance, through a multiple-beam interference effect utilizing a group of apertures that in themselves do not meet this requirement, can in principle be applied for providing multiplexed high-density data recording/storage.

A possible implementation of the beam carrying readily retrievable information about the bit pattern can be a beam originating from the 22 bit pattern irradiated by 21 coherent or incoherent light beams and being apertured by an aperture 23 at least at a relatively large distance from the bit pattern and in the vicinity of the pattern's axis, which forms the image 24 of the bit pattern through an imaging in which the bit pattern acts as object (approximately 2f-2f imaging is applied in the drawing).

The bit pattern to be recorded can be displayed by means of a liquid crystal modulator 25, which has liquid crystal molecules 29 introduced into a transparent multilayer arrangement consisting of electrode 26 and dielectric 27 layers, through a small bore disposed perpendicularly with respect to the layers.

With the application of two voltage levels this modulator arrangement can display any bit pattern, in the sense that locations of the 22 bit pattern representing 0s and 1s have different effect on the 21 incident beam. The bit pattern can be displayed by other means, such as utilizing an electro-optical modulator. In the context of the present invention the term “image” is used in a general sense, meaning that some characteristic feature of light is significantly different in locations representing 0s from locations representing 1s. The most efficient illumination of this arrangement (the illumination for which the loss from input light power is the smallest) is a conical, or alternatively, (multiply) apertured conical, coherent or incoherent illumination.

Such an illumination can be provided with little loss and sufficient intensity by means of imaging a long and straight light-emitting volume, or the output of a Bessel-beam laser resonator, onto the bit pattern. From the aspect of bit pattern illumination the application of the above mentioned, Bessel-type beams (for example made of Gauss beams by means of a conic lens) is more advantageous. The beams should be imaged such that the imaging conforms to the bit pattern in a way that the smallest cylindrically shaped volume containing the pattern should contain the focal volume of the zero-order Bessel beam, or in case of partially azimuthal polarization, that of the first order Besser beam.

This provides high contrast for the imaging, because according to my calculations the entire energy flow crosses this cylindrical surface. In case a Bessel-Gauss beam or other multiple-beam interference effect is applied, as the bit pattern has a length shorter than the bounded focal line, its axial position should conform to the centre of the focal volume for the uniform illumination of the pattern. Alternatively, considering the weakening of the data carrying beam in the storage media or in the modulator, we must implement such illumination of the bit pattern that would guarantee the uniform illumination of the coding volumes during writing regardless of their different horizontal position within the medium.

In case of high-aperture imaging radial polarization plays an important role in minimising the addressed volume. It can be achieved by means of coating having “S” and “P” polarization-dependent optical characteristics being disposed on an optical element used under incident angle significantly differ from zero, or through polarization rotation. Radially polarized Bessel-Gauss or other Bessel-type beam can be produced by means of diffraction optics from a linearly polarized beam (see explanations to FIG. 5).

The setup according to our invention provides that a bit pattern can be recorded at a given position of the storage medium, with the number of potential recording positions equaling those of one-dimensional methods.

The arrangement presented in FIG. 2 is capable of implementing the micromachining also in a general sens. For instance, if we make beam 21 a short-pulse laser beam and the create the image of bit pattern 22 in a material showing two-photon photopolymerisation. Inside this material we can create—through sufficiently refined and controllable moving—three-dimensional structures produceable by imaging various bit pattern 22 into the different positions of the substratum. It can be further noted that the writing device on FIG. 2, besides that offers data writing also with no rotation-symmetrical arrangement and with beam perpendicular to the modulated pattern, cannot create 24 bit images with an axis parallel to the medium surface.

The significance of this is that data multiplexing can be implemented with the help of bit patterns created in the plane of an optic disk. In this case the relative lateral position of the bit volumes is recorded and the radial positions differ so that the bit volumes do not necessarily touch. In this case we write wide tracks in a given layer. To increase the extent of multiplexing one can—with an appropriate holographic setup—easily write several tracks simultaneously on several superposed layers. Then the relative positions and patterns resulted within each track on each layer would differ.

In FIG. 3 an arrangement utilizing a holographic optical element 33 and 38 is presented. In case of the surface hologram the geometry gets slightly modified and angle between the plane and the direction of the reference beams must be as little as possible, ideally less than 10 degree.

Bit pattern 31 then appears as a real image in the medium 32

The holographic imaging element 33 performs the role of focusing incident laser beams 34 coming at different angles onto different layers 35 and to lateral positions slightly differing from one another if necessary (e.g. for the sake of hologram quality and for reducing heat load) but keeping these lateral positions fixed relative to one another, with focusing carried out in a diffraction-limited way and with high aperture.

This task cannot be achieved with conventional optical elements in case multiple macroscopic laser sources are applied, while it is known in holography that reference beams with different direction snake possible to register many independent images on one holography. That is, in our case, every single reference beam can record and reproduce a high-aperture image-beam.

In this arrangement information is stored during recording by a laser source 34 of a given direction, wave-length and polarization writing to a given layer 35 and eventually to given relative radial position, so that individual bits can be recorded due to the polarization stain, wave-length or the lack/existence of light entering the imaging element

The holographic imaging optic is capable of effectively generating a radially polarized output 36 from an input beam 37 that is linearly polarized in a suitable direction.

In this setup it is preferable to apply a focusing with the smallest possible focal depth instead of a Bessel-type focusing when the bit volumes have different lateral positions.

The holographic imaging element 38 capable of reading data can produce the necessary reading beam by using just one reference beam, given that the image beam is the optical axis of the reference beam. There is no absolute need to use the traditional diffractional and other optic elements. FIG. 3 shows the beam as radially polarized but that does not need to be so.

A Bessel-type beam or—in case when the lateral position differs between the layers Bessel-type beams—an image beam with its optic axis closes an angle greater than 5 degree.

Also, the holographic imaging element can be applied to provide imaging correction for layers located at different distances from the surface of the storage medium.

FIG. 4 shows a confocal optical setup adapted for retrieving the information carried by a bit pattern from light emitted in an active or passive manner by the illuminated pattern.

Linear illumination required for volumetric data storage may be provided by conventional laser beams.

However, for instance in case using of an edge emitting laser diode focused by cylinder lenses gets displaced, caused an occasional shift in the position of the storage disc, this displacement is not oriented in the direction given by the focal line.

Because the magnitude of this displacement falls in the range of the axial position shift of the disc, effective confocal detection of the bit pattern cannot be provided even for disc position shifts of a few micrometers.

The confocal filtering is an essential element of safe detection: it diminishes the background of any real image appearing within the optical imaging setup by applying an aperture.

Thus, —although other illumination and bit block orientation differing from perpendicular as well as the diffuse system of focus-volumes can also be detected in an appropriate confocal setup (using slit and/or untransparent surface pinhole system per aperture)—, it is expedient to apply a bit block 41 oriented perpendicularly to the surface, and for illuminating (42) it a multiple-beam interference effect, or in borderline cases, a Bessel-Gauss beam can be expediently applied because in these cases the optical axis of illumination may coincide with the direction of the bit block.

In the process of detection of diffuse bitblock, the filtering of the background should be performed so that the positions of the images of emitting/transmitting spaces of the bitblock be connected to little pinholes or optical fiber ends to guide the light to the detector.

The low background simultaneous detection of number of bit positions by a holographic element using divergent number of reference beams can happen both on the illuminated side of the medium or on its opposite side. The FIG. 3 presents a holographic writing element with the reversed beam path, naturally adjusted to the wave-length issued by the bit-pattern.

The reading holographic element can interpret radiation from different bit spaces as a reference beam and emits beams that can be made to correspond to single bits and can be imaged to a detector.

Detecting element can be an illumination element functioning with several references. Then the signal travelling backward—if its wave-length is near to the one of the illuminator—can be separated by simple optic means from the path of the reference beam going towards the holographic element (e.g. by means of dichroic mirror).

Construction of a holographic element by registering several holograms can also be done by producing an illuminating beam through imaging one or several references, while further holograms, equal in number to the bit block, interpret the radiation from every single bit space and produce easily detectable image beams, which can be differentiaterd from one another and from the reference beams of the illumination in a limited space.

The advantages of the optic axial illumination with the direction identical to the direction of the linear bit pattern perpendicular to the medium surface will be demonstrated below.

As far as the image of the bit block, appearing on the spatial filter applied for confocal detection, is concerned, for the effective operation of the filter it is important to apply a high-aperture imaging 43 (in specific cases, utilizing multiple elements) in the direction perpendicular to the bit block, or utilize the multiple-beam interference of information-carrying beams crossing at a relatively high angle, which results in a high effective aperture.

The minimal required numeric aperture in the direction of the bit block is determined only by the requirement that the images of individual volume elements of the bit pattern do not overlap on the detector 47.

A particular advantage of our system applied for reading normally oriented bit blocks is that, as far as the light source/storage medium/detector setup is concerned, the orientation and position of the optical axis of illumination, the orientation and position of the axis of the bit block, and the optimal position of the spatial filter 44 applied for confocal detection are independent of the axial position shift 45 of the storage disc, which is the most difficult to control of all uncertainty factors concerning disc position.

In order to improve the quality of imaging on the slit or, in case an imaging system generating a sequence of multiple real images is applied, on the multiple-slit system, optical correction elements 46 or alternatively holographic elements can also be utilized.

From the aspect of detection Bessel-type beams have the special advantage that the maximum of the zero-order Bessel function is surrounded by a dark annular area This effect, which does not occur in confocal detection systems utilizing conventional light sources, enhances the contrast of detection.

The system has a relatively high tolerance (a few hundredths of millimeters) for position shifts (displacements) occurring in the direction of the optical axis. This shift does not reduce data safety due to the redundancies of the CCD detector and to the markers disposed at both ends of the bit pattern. It is preferable to apply a reflective optical arrangement.

The above-mentioned generalization, to with that the detection of a bit pattern can be seen as a microscopic analysing of a sample particularly well applies in case of the arrangements presented on the FIG. 4. Illumination 42 detects the optical inhomogeneity in the place of the medium carrying an accidental 41 bit pattern. A three-dimensional image of the pattern can be put together out of the images taken by detector 47 by using different relative positions of the sample and the detecting device.

The practical application of our data storage method can be seriously hindered by the difficulties arising from the complicated generation of Bessel-type beams.

Bessel type beam can be resulted most easily with the help of holographic optics by using continous wave laser.

Mode-locked Bessel-type beam production requires combination of a mode-locked laser source and special optics or can be resulted by special lasers in one step. However, as it has been mentioned in relation to the recording of bit patterns, this beam type has a peculiar characteristics, namely that the entire energy flow crosses a narrow cylindrical volume surrounding the focal volume. This property makes it possible to design a robust laser resonator generating Bessel-Gauss beam.

The proposed laser arrangements are shown in FIG. 5. Resonator setups illustrated in FIGS. 5a and 5b are rotationally symmetrical to symmetry axis 53. The so-called folding of the resonator does not change these arrangements significantly.

According to our recognition, a number of conventional laser resonators applied for generating Gauss beams have a stable Bessel-Gauss mode besides operating in a conventional way, with a beam path parallel with the optical axis.

5b shows the axial section of the Bessel-Gauss mode of a lens-stabilized plane-plane mirror setup. The stability conditions can be computed easily using the ABCD matrix method well known for those skilled in the art.

Similar results can be obtained for a resonator comprising a slightly modified reflective optical arrangement (FIG. 5a). A key feature of realizing a Bessel-Gauss beam output is that an optical imaging element/elements 51 (which can be either reflective, refractive or holographic elements, or elements with surface diffraction patterns) should be applied in the resonator such that the non-paraxial beam path 52 realized by these elements should be confined to the resonator (this requires optical elements with sufficiently high aperture).

An important type of possible resonator arrangements of this type exploits significant spherical aberration of the applied optical imaging. In more complicated resonators it is possible to create more cross of optic axis and the non-paraxial beam path. The purpose of this could be e.g. spacial differentiation between the place of processes of amplifying and mode-synchronizing.

However, we have recognised that the existence of stable Bessel-Gauss modes usually co-occur with the existence of stable linear line like off-axis modes.

Thus, in usual cases there are special conditions needed for the excitability of the Bessel-Gauss mode. This is obvious in the case where no blocking is applied or no loss is introduced with respect to the paraxial beam path.

In a resonator with a specially selected pumped volume it can be provided that the gain of the Gauss-mode operation be significantly lower than that of the Bessel-Gauss mode, while the Bessel-Gauss mode is prevented from collapsing into non-paraxial, linear beam paths.

Based on the characteristic feature of Bessel-Gauss beams, namely that the entire energy flow crosses a narrow cylindrical surface surrounding the focal volume, population inversion should be generated in the vicinity of the focal area of the Bessel-Gauss mode, in a volume significantly smaller than the mode volume portion of the paraxial or linear off-axis beam paths falling into the laser-active material can provide that the gain of the Bessel-Gauss mode rises above the laser threshold while the gains of other modes remain below it.

The cornerstone for pumping optimization is that population inversion should be generated in the entire focal depth, or else the diffraction losses of the Bessel-Gauss mode may increase by multiple orders of magnitude. Alternatively the beam can get deformed, whose deformation can be predicted and eventually used.

By means of adjusting the stability ranges of the resonator in special cases it can even be provided that, although the Bessel-Gauss mode is stable in the axial section, in a direction perpendicular to that the mode is not stable. In this case the resonator has a Bessel-Gauss mode but the linear off-axis beam paths disappear and only the Gauss mode should be eliminated, which can be provided by simple means.

Mode competition can be controlled trivially by suitably sized and positioned slits and absorbents to achieve a relatively higher gain for the Bessel-Gauss mode.

The buildup of the Bessel-Gauss mode can be further fostered if the refractive or suitably coated reflective elements have relatively smaller reflection loss for the Bessel-Gauss mode.

Such a (main or supplementary) role can be performed also by birefringent elements. The birefringent element can be the laser-active material 54 itself, the effect of which should be taken into account in the design process of the resonator.

Different reflection losses pertaining to different polarization states of the Bessel-Gauss mode can be utilized to produce radially or azimuthally polarized beams, which can be brought about in the simplest way by applying thin-film optical coatings having different reflection characteristics for S- and P-polarized light, or, in case of refractive optics it could be sufficient to utilize the polarization-dependent reflection occurring in the proximity of the Brewster angle.

It should be noted here that the application of diffracting surfaces is only expedient for producing azimuthal polarization e.g. on the back surface of the 54 amplifier material as end mirror, because dark (non-illuminated) rings are formed on the end mirror only in this polarization state.

With the help of birefringent elements beam manipulation aimed at producing beams of special polarization characteristics can be carried out not only inside the resonator but also utilizing an element disposed outside it. Thus, the usually radially polarized Bessel-Gauss output can be transformed e.g. into an azimuthally polarized beam utilizing a birefringent plate of suitable thickness and orientation, for example of circularly birefringent liquid crystal plate.

In FIG. 5c an implementation of the long and straight light emitting volume mentioned among suggested light source types in relation to FIG. 2 is illustrated. The laser resonator shown in FIG. 5c is implemented without any conventional coupling-out element (the figure shows only that portion of the beam path 59 which is of interest here, other elements being illustrated by a rectangle 55).

At a given section of the beam path the beam is coupled into an optical fibre 56 which comprises a grating 57 implanted/etched/ablated on its surface, with the grating 57 being adapted for coupling out the beam and producing emitted beam 10. Preferably, an end mirror 58 is evaporated on the other end of the fibre.

This out-coupling fibre section can also be comprised in a unidirectional ring laser, of course without the mirror at the fibre's end. With this arrangement it is also possible to provide light emission at the cylindrical surface of the fibre in a short-pulse regime, and polarization characteristics of the emitted light may also be better than in the case of conventional solutions. In case the beam coupled into the fibre is circularly polarized, this polarization state can be transformed to nearly radial for the output beam by means of a suitably anisotropic element E.g. slab cutted parallel to the axis of an uniaxial crystal can produce the suitable π/4 relative phase shift for the ordinary and extraordinary plane wave components.

From the point of view of continuous wave operation of this invention the production of the radially polarized Bessel-type beam is especially important. It can be resulted from a beam by holographic/diffraction optics, where the optic axis of the linearly polarized beam issued by any laser and the optic axis of the radially polarized Bessel-type image beam meet at an angle greater than 5 degree. In this case, it is possible to create even a radially polarized Bessel-type beam with the help of the setup on FIG. 3. The short pulse spreading in the Bessel-type beam can be generated by a combination of a conventional beam pulse laser and a non-spherical (e.g. conical) imaging.

FIG. 6 shows axis cut views of possible implementations of a pulsed Bessel-Gauss laser. For the purposes of the present invention the application of pulsed-regime operation is justified by the improved signal-to-noise ratio of multiphoton processes of the storage medium (to be described later) and the better controllability of heat propagation characteristics. The proposed pulsed Bessel-Gauss laser setup is much more simplier, than the conventional lasers. An important property of Bessel-Gauss resonators is that the geometry of the resonator can be generally described by a group delay dispersion (GDD) value (determined also by the wavelength-dependent refractive index of refractive elements), which is of crucial importance from the aspect of short-pulse operation.

Dispersion compensation inside the resonator should be designed taking into account this GDD value. For implementing dispersion compensation e.g. chirped mirrors or cylindrically symmetrical refractive surfaces can be applied. Angular dispersion, occurring as an inherent property of the resonator, makes it possible to radically simplify the setup of ultrashort-pulse lasers. This opens up possibilities of miniaturization for our invention

For short-pulse operation an indispensable element is the mode-synchronization unit 61. This can be implemented by exploiting a characteristic feature of Bessel-Gauss beams 62, namely that the entire energy flow crosses the cylindrical surface of a narrow cylindrical volume portion 63 surrounding the focal volume, because mode synchronization using saturable absorbents requires high power density, and in our case mode coupling should be effective for the entire beam. Thus, our mode synchronization unit comprises a spatial portion that covers a focal volume of the Bessel-Gauss mode, and expediently also provides a saturable absorption effect at the wavelength of the laser, at least in the spatial portion in question.

To maximize the power density it is generally preferable to fill the focus volume by the saturable absorbent volume. Besides that the absorbent purposefully at least in the focus space portion impacts as saturable absorbent.

To obtain a simple laser arrangement the 61 mode synchronization unit and the gain medium can be implemented as a single element in case a solid state active material 65 is applied, with saturable absorber material 64, for instance quantum dots, being introduced through a small bore into the focal volume generated in the active material.

The question of Q-switching arises primarily in relation to the implementation of data recording. With a high repetition rate Q-switched Bessel-Gauss laser it is recommended to apply a saturable absorber material 67 as well, but with longer regeneration time than in the case when short pulses are produced. The location of the absorber material is not a critical factor, and thus it can be disposed at a greater distance from the focal volume if that is required for achieving the desired repetition rate.

It should be mentioned at this point that the pulsed laser according to our invention, combined with the imaging optics described referring to FIG. 2 and with a modulator element, can be capable of radically increasing the speed of multiphoton micromachining processes as it is capable of operating on a three-dimensional block, while conventional laser apparatuses can operate only at a single point at the same time.

[symbol]

It should also be noted that, combined with the detection arrangement illustrated in FIG. 4, our pulsed laser can be applied in the field of real-time multiphoton fluorescence microscopy.

FIGS. 7a-7b show two types of storage material adapted for being utilized for our data storage method.

It can generally be said that the implementation of the invention does not necessarily require forming any special inner structure within the medium. The only requirement to the material of the medium is that in the process of writing, the content of the volume to be written should undergo such a modification that could perdure in the absence of other impacts as rewriting or deleting.

To achieve the necessary speed of the writing process it is practical to apply some photophysical/photochemical reaction. Furthermore to achieve a clear localization it is desirable to induce a kind of phase change. The photoreaction in process can be oriented towards the synthesis of a new molecule, its isomerization or interaction with the molecule serving as a liquid crystal matrix etc. Through this during writing we enact changes in the optical parameters on the wave-length of the reading laser. We can eventually make it into a fluorescence with desired parameters or modify the existing fluorescence of the medium.

It is desirable to use molecules with multiphoton absorption and efficient fluorescent emission and syntethisation, activation of these during the writing process. By the way of using reversible photoreaction deleting and rewriting reachable. In case of using phase change it is desirable to use the heating effect for change the aggregate or other phase change e.g. modify the viscosity. In this case, when the recording process is realized by the change of the molecular structure (e.g. isomerization), or physical contact is needed of the reagents, the initial phase can block the procedure and the final phase indicated by the higher temperature makes it possible the writing due to higher movability. The key molecules of the writing are separable if needed, e.g. the active material can diffuse in the matrix or in case the molecules in the “0” and “1” volumes interact such way, that the information vanishes. When the separation is needed, inactive matrix proposed separate the active droplets, with matrix does not let the diffusion of the active molecules. Submicron size of the droplets is proposed. This structure serves the longtime reliability of the storage and also gives a new parameter for planning and controlling the heat diffusion during the writing process. It can be important due to the abruptly bounded bit volumes and minimizing of them that the heat diffusion will be quick enough in macroscopic scale. In some cases high heat capacity of the inactive matrix, or in case of droplets with good heat transfer features weak heat transfer features of the inactive maniac required. Besides the absorption must be much more intensive in the droplets, than in the matrix. Because the undesired accumulation of the heat could cause phase change, mistake during writing or loss of information. During the self organizing writing it is suitable to use such system of ploimer or glass dispersed photosensitive droplets, where the optical and thermic features of the droplets and the inactive matrix significantly differ. Regarding our system is emphasized the sharp maximum characteristic of the zero-order Bessel-Gauss beam appears in case of strong focusing of a radially polarized beam as a strong maximum of the field strength component parallel with the optical axis. It is important to utilize a data storage material that undergoes modulation by the radially polarized Bessel-Gauss beam in an area that is as small as possible and is abruptly bounded.

This can be achieved by providing a material for the storage medium that is anisotropic and its interaction with the field strength component parallel with the optical axis is greater than with components normal to the axis. According to our recognition the writable storage medium applicable for the purposes of the invention can be implemented as a system (FIG. 7a) of liquid crystal droplets 73 doped with photosensitive molecules 71 dispersed in a polymer matrix 2 (PDLC), having a typical thickness of a few tenths of millimeters but at most 1-2 millimeters, with the directors of liquid crystal droplets 74 being oriented in a direction perpendicular to the surface of the storage medium, maximizing the absorption within the droplets.

E.g. the doped liquid crystal droplets of the data storage material may react more intensively to the axial field strength component, preferably having a far greater absorption coefficient for this field direction than for the direction perpendicular to it. The polarization dependence of the absorption can be reversed also.

In case of radially polarized Bessel-Gauss beam directors directed into the beam propagation direction in the stage material are suitable. Because of symmetry reasons propagation and director direction perpendicular to the media surface is desired.

The storage material may be provided in a disc-like or other shape, conforming to the applied positioning method. Bounding surfaces of the storage medium are covered with a protective layer 75 providing increased mechanical stability.

For inscribing information it is preferable to utilize a threshold phenomenon or a sufficiently fast nonlinear effect Such a suitable threshold phenomenon can be the thermally induced phase transition of the liquid crystal. The material of the liquid crystal droplets is chosen such that it has phase transition temperature values ensuring that at room temperature (with a reasonable margin) the droplets have an ordered phase, blocking the reactions of dissolved molecules contained in them.

During recording, however, the material in its lower-viscosity state (resulting from getting illuminated at locations conforming to the bit pattern) should allow a reaction, e.g. photochemical reaction induced either by the laser beam inscribing the phase transition pattern conforming of the bit pattern or another illumination 76 (typically at a wavelength different from the laser causing the phase transition) to proceed. The localisation of photochemical reagents is carried out by the polymer/glass matrix structure that does not allow to pass reagents from one droplet to another. In order to provide as small data storage volume elements as possible, and also for the sake of exact recording localization dispersed structure of sub-micron droplets should be applied.

The nano-PDLC or similar structure may provide refractive index matching for certain propagation directions at different wavelengths in a plannable manner, and may also be a means for achieving slightly/partially polarized fluorescence emission. By applying a voltage to a conductive layer 77 disposed on the two sides of the data storage disc, refractive index matching may be different for reading and writing. An important consideration for designing the thermal properties of the medium is that heat accumulated at a given location during recording should not cause without the intention of inscribing a bit pattern such a transition in the liquid crystal droplet that could enable a photoreaction to take place. Beside the different heat diffusion features of the inactive matrix from that of the droplets application of pulsed laser can play important role The application of a Q-switched laser pulse helps reduce the heat load of the storage medium. The photoreaction may be directed towards synthesising new molecules, towards molecular isomerisation, or to an interaction with the molecules of the liquid crystal matrix. During recording our aim is to change optical properties of the medium at the wavelength applied for reading. It is preferable to apply molecules producing multiphoton absorption and effective emission, or to synthesize or activate such molecules during data inscription.

The multilayer data storage medium structure shown in FIG. 7b can be produced on an industrial scale, due to the fact that the separate levels of the suggested multilevel structure can be separately written during fabrication. Essential point for the production of such medium is the precise positioning of the separately written levels.

Although—because of the required careful positioning of bit blocks 78 and due to the complex multilayer structure itself—the manufacturing process will likely be more complex than the production of conventional storage media, other suggested solutions for multiplexed data recording at comparably high data rates presently lay far more remote from industrial-scale production. One realization of the coding of a bit stored in data storage layers 79 by the existence or lack of a dye spot 80 showing multiphoton fluorescence, with the layers 79 being separated from each other by optically inactive layers 81 having a thickness equaling the separation distance.

The absorption of the spots is in the thousandth regime because of minimizing the aberration of the reading beam and the fluorescent life time is short, under nanosecond. The bit spots can be also diffusive or reflective elements. The latter case is important at use of 33 or 38 holographic elements for reading.

### Summary of the Advantages of the Suggested Data Storage System

The suggested data storage system is capable of simultaneously writing and reading 32, 64 or even 128 bits (depending on the applied processor technology) at a single position of the storage medium, significantly increasing the speed of both data recording and retrieval, and even opens up possibilities for direct data delivery to optical processors. With the application of the invention the storage capacity of optical storage media can be increased to a few hundred Gbytes. Our system can be compatible with both present-day and forthcoming DVD standards, and is capable of reading a storage medium that can be produced on an industrial scale. By exploiting analogous processes, certain elements of the system can be utilized in the fields of confocal fluorescence microscopy and multiphoton micromachining. The Bessel-Gauss laser resonator, which is the light source of preference of the present invention, may provide a solution for generating ultrashort pulses in a manner simpler than existing methods. Our system records information on the storage medium in a self-adjusting way and thus no special layer structure is required. During data retrieval the system is especially stable/robust with respect to the axial position uncertainty of the medium.

1. Method of information storage on an optic medium, in the course of which we create a multilateral bit pattern within the medium by means of an imaging beam produced by a light-emitting setup. Information is stored by imaging a bit block into a data storage medium in a way that the imaging element creates different focus volumes for coding every single bit in different positions of the medium, while the respective positions of the volumes are fixed.

2. The method described in 1. characterised by the fact the bit pattern is realized by imaging it as a linen bit block written onto superposed layers in a way that the direction of the bit block constitutes an angle of at least 5 degree with the propagation direction of the components of the most intensive plane-wave of the imaging beam

3. Implementation of an appliance based on the method of claim 1, characterised by the fact that the beam imaging the bit pattern to be recorded is produced with the application of a light modulator whose modulating volumes are arranged into a block.

4. Implementation of an appliance based on the method of claim 1, characterised by the fact that we use a Bessel-type beam or use simultaneously several coherent beams for the imaging of the bit pattern to be recorded.

5. Method of claim 1 with the creation of the bit pattern by means of a holographic element capable of imaging optical reference beams whose number is identical or exceeds the number of the bits to be recorded.

6. Method of claim 1 with specification that the elements belonging to different positions within the multilateral bit pattern are recorded into the optic medium in a single step. In the course of the writing step the positions of single bits of the emerging bit pattern within the optic medium are different.

7. Method of readout of digital information from an optic medium carrying a multilateral bit-pattern by means of readout-beam directed to the surface of the medium and a photo-sensitive detector. Implemented so that the readout beam focused on fixed positions of the single bit-groups of the bit-pattern is used to illuminate the multilateral bit-pattern.

8. Method of claim 7 with the use of Bessel-type readout beam for the illumination of the bit pattern.

9. Method of claim 7 with the use of confocal detection for the readout of the multilateral bit-pattern and the use of confocal filtering with linear slit or slits and/or a pin-hole system and/or a combination of these.

10. Method of claim 7 with specification that the elements belonging to different positions within the multilateral bit pattern are readout from the optic medium in a single step. In the course of the readout step the positions of single bits of the emerging bit pattern within the optic medium are different.

11. Method for producing a Bessel-Gauss laser beam, characterised by the use of optical imaging element or elements that enable, by their size, the creation of non-paraxial mode; also the use of optical imaging element or elements with significant spherical aberration in order to cause the appearance of stable laser-modes at an angle with the optical axis.

12. Implementation of the method of claim 11, characterised by the relatively higher gain per time unit of the non-paraxial Bessel-Gauss beam is provided by introducing a loss with respect to the paraxial beam path or by eliminating the paraxial beam path.

13. Implementation of the method of claim 11, characterised by the fact that the gain per time unit of the Bessel-Gauss beam is increased compared to the gain per time unit of other beam paths with the application of a population-inverted volume that is smaller than the mode volume portion of other beam paths falling into the laser-active material and is better conforming to the mode volume of the Bessel-Gauss mode.

14. Implementation of the method of claim 11, characterised by the use of at least one optical element with non-perpendicular angle of incidence; the reflection of optical elements, and coatings dependant on the polarization, or the birefringent elements or their combination result in significantly different losses of radial polarization state than those of azimuthal.

15. Optical medium to implement the method of claim 1 with a specification that at least one external surface of the medium, at a given volume depth depending on the light intensity and polarization, where the bit pattern is to be recorded, be made of a material showing storage modification as inner interaction.

16. Data storage medium as in claim 15, characterised by the fact that during bit-pattern recording the polymer or glass-matrix used to block or induce a given reaction by thermally induced phase transition should contain liquid crystal drops.

17. The data storage medium according to claim 16, characterised by the fact that this reaction is a photoreaction.

18. Data storage medium as in claim 15 with a specification that it is an optical multilayer data storage medium, wherein volume elements, which are contiguous to at least one of its surfaces and applied for data storage, are arranged into a linear pattern in the direction making an angle with the surface.

19. Implementation of a laser apparatus based on the method of claim 11, characterised by the fact that in a Bessel-Gauss focal volume of the apparatus, in the area of diffraction rings, a saturable absorbent is applied to provide mode-locked operation.

20. Method of claim 11 characterised by the use of a resonator setup having a stable Bessel-Gauss mode and at the same time unstable linear non-paraxial modes.

21. Multilayer structure replicable optical medium to implement the method in claim 7 with the specification that the medium contains bit-patterns arranged in groups with fixed position relative to each other.
